(19) United States
(12) Patent Application Publication
(10) Pub. No.: US 2018/0198159 A1
(43) Pub. Date: Jul. 12, 2018

(54) LITHIUM ION SECONDARY BATTERY

(71) Applicant: NEC Corporation, Tokyo (JP)

(72) Inventor: Takeshi AZAMI, Tokyo (JP)

(73) Assignee: NEC Corporation, Tokyo (JP)

(21) Appl. No.: 15/742,184

(22) PCT Filed: Jul. 8, 2016
(86) PCT No.: PCT/JP2016/070253

§ 371 Date: Jan. 5, 2018

(30) Foreign Application Priority Data
Jul. 9, 2015 (JP) 2015-137887

(51) Int. Cl. H01M 10/0525; H01M 10/0569; H01M 10/0567; H01M 10/0585; H01M 4/133; H01M 4/48; H01M 4/70; H01M 4/62; B82Y 30/00

(52) U.S. Cl. CPC H01M 10/0525; H01M 10/0569; H01M 10/0567; H01M 10/0585; H01M 2004/028; H01M 4/48; H01M 4/70; H01M 4/623; B82Y 30/00; H01M 4/133

(57) ABSTRACT

Use of a silicon-based material in a negative electrode of a lithium ion secondary battery results in a decrease in discharge capacity and an increase in internal resistance. In order to overcome this, the lithium ion secondary battery according to the present invention is characterized in having a negative electrode comprising a carbon nanotube having a peak between 2600 and 2800 cm⁻¹ in a Raman spectrum obtained by Raman spectroscopy, a graphite, and a silicon oxide having a composition represented by SiOₓ (0<x≤2).

### TECHNICAL FIELD

The present invention relates to a lithium ion secondary battery, a method for manufacturing the same, and a vehicle using a lithium ion secondary battery.

### BACKGROUND ART

Lithium ion secondary batteries are characterized by their small size and large capacity and are widely used as power sources for electronic devices such as mobile phones and notebook computers, and have contributed to the improvement of the convenience of portable IT devices. In recent years, attention has also been drawn to the use in large-sized applications such as drive power supplies for motorcycles and automobiles, and storage batteries for smart grids. As the demand for lithium ion secondary batteries has increased and they are used in various fields, batteries have been required to have characteristics, such as further higher energy density, lifetime characteristics that can withstand long-term use, and usability under a wide range of temperature conditions.

Carbon materials are generally used in a negative electrode of lithium ion secondary batteries. On the other hand, it is also studied that silicon materials having a large absorbing and desorbing amount of lithium ions with respect to the unit volume are used in a negative electrode for the purpose of high energy density of the batteries. However, the silicon materials deteriorate when charge/discharge of lithium is repeated because they expand and contract. For this reason, they have a problem in cycle characteristics of the batteries.

Various proposals have been made in order to improve the cycle characteristics of the lithium ion secondary batteries using the silicon materials in negative electrodes. Patent Document 1 discloses batteries can be improved in rate characteristics and cycle characteristics by a negative electrode comprising (a) a negative electrode active material such as silicon oxide covered with a carbon material, (b) a graphite-based material, and (c) a carbon material other than the graphite-based materials, such as acetylene black, Ketjen black, powders containing graphite crystals, or conductive carbon fiber.

### CITATION LIST

### Patent Document

Patent Document 1: WO2012/140790

### SUMMARY OF INVENTION

### Technical Problem

However, there is a problem in that the decrease in discharge capacity and the increase in internal resistance still have been seen in the lithium ion secondary battery of the above patent document when charge/discharge cycles are repeated, and further improvement of the cycle characteristics is needed.

An object of the present invention is to provide a lithium ion secondary battery in which the decrease in discharge capacity and the increase in internal resistance in using the silicon materials in a negative electrode, which are the above problem, are suppressed, and the cycle characteristics are improved.

### Solution to Problem

The lithium ion secondary battery according to the present invention comprises a negative electrode comprising a carbon nanotube having a peak between 2600 and 2800 cm⁻¹ in a Raman spectrum obtained by Raman spectroscopy, a graphite, and a silicon oxide having a composition represented by SiOₓ (0<x≤2).

### Advantageous Effect of Invention

According to the present invention, a lithium ion secondary battery having more improved cycle characteristics can be provided.

### BRIEF DESCRIPTION OF DRAWING

FIG. 1 is an exploded perspective view showing a basic structure of a film package battery.

FIG. 2 is a cross-sectional view schematically showing a cross section of the battery of FIG. 1.

FIG. 3 shows Raman spectrums of three types of graphite having different peak intensity of D band, G band, and 2D band.

FIG. 4 shows Raman spectrums of three types of silicon oxides having different peak intensity of D band, G band, and 2D band.

FIG. 5 shows Raman spectrums of three types of carbon nanotubes having different peak intensity of D band, G band, and 2D band.

### DESCRIPTION OF EMBODIMENTS

Embodiments of the present invention will be described with respect to individual members of lithium ion secondary batteries.

<Negative Electrode>

The negative electrode has a structure in which the negative electrode active material is laminated on a current collector as a negative electrode active material layer integrated by a negative electrode binder. The negative electrode active material is a material capable of reversibly occluding and releasing lithium ions according to charge and discharge in a negative electrode.

In the present embodiment, the negative electrode comprises graphite and silicon oxide as a negative electrode active material and a carbon nanotube as a conductive agent.

The graphite to be used may be either natural graphite or artificial graphite. Shape of the graphite is not particularly limited and any shape may be acceptable. Examples of the natural graphite include scaly graphite, flaky graphite, and amorphous graphite, and examples of the artificial graphite include spherical artificial graphite such as massive artificial graphite and flaky artificial graphite, and MCMB (Mesocarbon microbeads). The graphite to be used may be coated with a carbon material or the like. The median diameter (D_{50G}) of the graphite particles is preferably within the range of 5.0 μm<D_{50G}<25.0 μm. The negative electrode preferably comprises the graphite in an amount of 50% by mass or more, and more preferably 70% by mass or more, based on the total amount of the negative electrode active material contained in the negative electrode. In addition, the negative electrode preferably comprises the graphite in an amount of 97% by mass or less based on the total amount of the negative electrode active material contained in the negative electrode.

The silicon oxide to be used has a composition represented by SiOₓ (0<x≤2). An especially preferred silicon oxide is SiO. With respect to the silicon oxide, it is preferable that the surfaces of the particles are coated with a carbon material. When the carbon-coated silicon oxide particles are used, a lithium ion secondary battery excellent in cycle characteristics can be provided. The median diameter (D_{50S}) of the silicon oxide particles is preferably within the range of 0.5 μm<D_{50S}<10.0 μm. The negative electrode preferably comprises silicon oxide in an amount of 1% by mass or more, and more preferably 3% by mass or more, based on the total amount of the negative electrode active material contained in the negative electrode. In addition, the negative electrode preferably comprises the silicon oxide in an amount of 20% by mass or less, and more preferably 10% by mass or less, based on the total amount of the negative electrode active material contained in the negative electrode.

Carbon nanotubes are a carbon material formed from planar graphene sheet having 6 membered rings of carbon, and act as a conductive agent in the secondary batteries. The carbon nanotubes are formed by making the planar graphene sheet having 6 membered rings of carbon cylindrical, and may have a single layer or a coaxial multilayered structure. Both ends of the cylindrical carbon nanotube may be opened and may be closed with hemispherical fullerene containing 5-membered rings or 7-membered rings of carbon. The diameter of the outermost cylinder of the carbon nanotubes is, for example, preferably 0.5 nm or more and 50 nm or less. The average length (D_{50C}) of the carbon nanotubes is preferably within the range of 0.05 μm<D_{50C}<5.0 μm. The negative electrode preferably comprises the carbon nanotubes in an amount of 0.5% by mass or more, and more preferably 1.0% by mass or more, based on the total amount of the negative electrode active material contained in the negative electrode. In addition, the negative electrode preferably comprises the carbon nanotubes in an amount of 20% by mass or less, and more preferably 5% by mass or less, based on the total amount of the negative electrode active material contained in the negative electrode.

With respect to the carbon materials having a graphene layer such as graphite and carbon nanotubes, properties thereof, such as crystallinity and the number of layers, can be confirmed by Raman spectroscopy. In a Raman spectrum obtained by Raman spectroscopy, the peak which occurs in the range of 2600 to 2800 cm⁻¹ (herein, referred as to “2D band”), the peak due to in-plane vibration of the graphene which occurs in the range of 1500 to 1700 cm⁻¹ (herein, referred as to “G band”), and the peak due to defects in crystal structure which occurs in the range of 1000 to 1400 cm⁻¹ (herein, referred as to “D band”) are commonly used for evaluation of the crystal structure of the graphene layer.

With respect to Raman spectrum of carbon materials, when the carbon material has high peak intensity of G band, it tends to have high crystallinity, and when the carbon material has high peak intensity of D band, its crystal fall into disorder and it tends to be structurally defective. Therefore, the ratio of the peak intensity (I_{G}) of G band and the peak intensity (I_{D}) of D band has been used as an index of the crystallinity, and a large value thereof means that the carbon material has high crystallinity.

2D band also can be used as an index in the same manner. 2D band is known as an overtone mode of D band. The present inventor found out that I_{G}/I_{D} has a correlation with the ratio (I_{2D}/I_{D}) of the peak intensity (I_{2D}) of 2D band and the peak intensity (I_{D}) of D band while he investigated Raman spectroscopy of the graphite, silicon oxides, and carbon nanotubes, and the battery properties in detail. I_{G}/I_{D} and I_{2D}/I_{D} relatively show a positive correlation, and when I_{G}/I_{D} is large, I_{2D}/I_{D} is also large.

In addition, when the present inventor investigated results of Raman spectroscopy and battery properties in detail, he found out that 2D band does not simply follow D band as its overtone mode, and there are a type following D band sensitively and a type not following D band so much, depending on characteristics of the carbon materials. Examples of methods to make the peak intensity of 2D band large regardless of D band include increasing temperature at the time of forming graphite materials or carbon nanotubes and increasing crystallinity thereof.

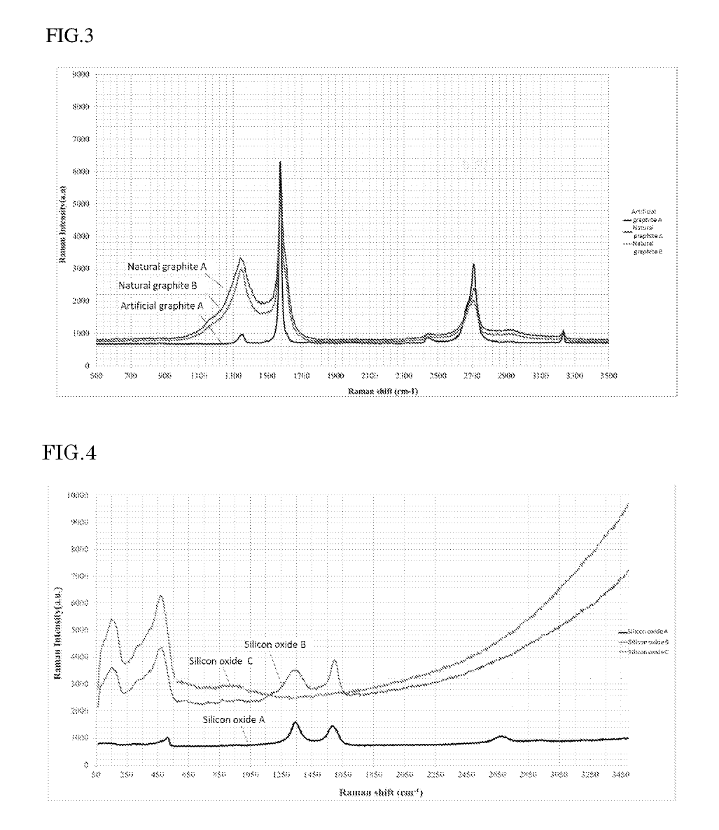

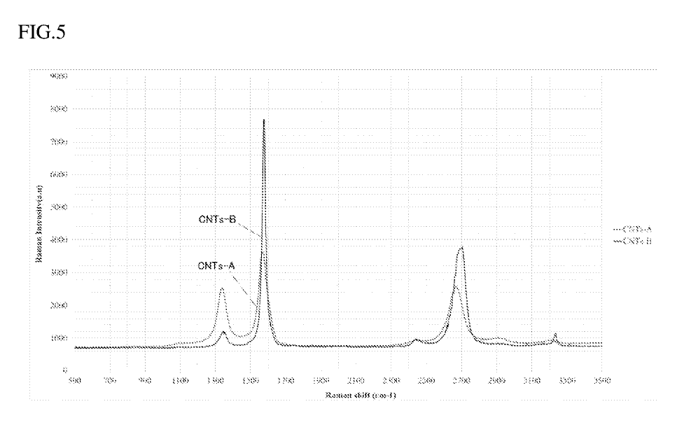

It is extremely effective in battery development to investigate carbon materials to be used with Raman spectroscopy in detail on the basis of such a trend of the properties and Raman spectrums of the carbon materials so as to select lithium ion secondary battery materials. FIGS. 3 to 5 show examples of Raman spectrums of the graphite, silicon oxides, and carbon nanotubes, which may be used in the present embodiment.

Carbon nanotubes having 2D band in a Raman spectrum are used in the negative electrode of the present embodiment. Cycle characteristics of batteries can be improved by using the carbon nanotubes having 2D band in a Raman spectrum in the negative electrode. Although the improvement mechanism of the negative electrode based on presence/absence of 2D band is not clear in detail, it is considered that low resistance SEI (Solid Electrolyte Interface) film is readily formed on the carbon surface of the materials having a peak in 2D band, and, in addition, the materials having a peak in 2D band have the effect of improving electrolyte solution retention property, and therefore the cycle characteristics are improved.

In order to increase the cycle retention ratio and reduce the resistance increase rate, it is preferable that the graphite, silicon oxides and carbon nanotubes contained in the negative electrode exhibit a Raman spectrum having the peak intensity ratios and/or the peak area ratios which will be described later, when they are analyzed by Raman spectroscopy. The silicon oxide is preferably coated with carbon. Raman spectrums of the silicon oxide will be described later. In this case, the silicon oxide is coated with carbon, and the Raman spectrums mean those obtained by Raman spectroscopy of the silicon oxide coated with carbon. It is considered that the carbon nanotubes showing the peak ratios described below tend to form conductive paths between a graphite particle and a silicon oxide particle and to suppress destruction of the carbon coating on the surface of the graphite by the silicon oxide. In addition, since the carbon nanotubes exist in the gap between these particles, the graphite particles and the silicon oxide particles showing the peak ratios described below can follow the expansion and contraction thereof during charge/discharge. For this reason, the cycle characteristics can be improved also by particularly reducing damage of the graphite.

When the ratio (I_{G}/I_{D}) of the peak intensity (I_{G}) of G band and the peak intensity (I_{D}) of D band in a Raman spectrum obtained by Raman spectroscopy is referred to as I_{GG}/I_{GD} with respect to the graphite, I_{SG}/I_{SD} with respect to the silicon oxide, and I_{CG}/I_{CD} with respect to the carbon nanotube, the peak intensity ratios of the graphite, silicon oxide, and carbon nanotube contained in the negative electrode preferably satisfy at least one of the following equations, and more preferably all of the following equations.

1<I_{GG}/I_{G}D<20

0.8<I_{SG}/I_{SD}<2

1<I_{CG}/I_{CD}<16

Among the above ranges, I_{GG}/I_{GD} is preferably high, I_{SG}/I_{SD} is preferably close to 1.0, and I_{CG}/I_{CD} is preferably close to I_{SG}/I_{SD}. Therefore, the peak intensity ratios of the graphite, silicon oxide, and carbon nanotube contained in the negative electrode preferably satisfy at least one of the following equations, and more preferably all of the following equations.

10<I_{GG}/I_{G}D<20

0.9<I_{SG}/I_{SD}<1.2

1<I_{CG}/I_{CD}<2

When the ratio (S_{G}/S_{D}) of the peak area (S_{G}) of G band and the peak area (S_{D}) of D band in a Raman spectrum obtained by Raman spectroscopy is referred to as S_{GG}/S_{GD} with respect to the graphite, S_{SG}/S_{SD} with respect to the silicon oxide, and S_{CG}/S_{CD} with respect to the carbon nanotube, the peak area ratios of the graphite, silicon oxide, and carbon nanotube contained in the negative electrode preferably satisfy at least one of the following equations, and more preferably all of the following equations.

1<S_{GG}/S_{G}D<10

0.8<S_{SG}/S_{SD}<1.2

1<S_{CG}/S_{CD}<10

Among the above ranges, S_{GG}/S_{GD} is preferably high, S_{SG}/S_{SD} is preferably close to 1.0, and S_{CG}/S_{CD} is preferably close to S_{SG}/S_{SD}. Therefore, the peak area ratios of the graphite, silicon oxide, and carbon nanotube contained in the negative electrode preferably satisfy at least one of the following equations, and more preferably all of the following equations.

4<S_{GG}/S_{GD}<10

0.9<S_{SG}/S_{SD}<1.2

1<S_{CG}/S_{CD}<2

When the ratio (I_{2D}/I_{D}) of the peak intensity (I_{2D}) of 2D band and the peak intensity (I_{D}) of D band in a Raman spectrum obtained by Raman spectroscopy is referred to as I_{G2}/I_{GD} with respect to the graphite, I_{S2D}/I_{SD} with respect to the silicon oxide, and I_{C2D}/I_{CD} with respect to the carbon nanotube, the peak intensity ratios of the graphite, silicon oxide, and carbon nanotube contained in the negative electrode preferably satisfy at least one of the following equations, and more preferably all of the following equations.

0.5<I_{G2D}/I_{GD}<10

0.2<I_{S2D}/I_{SD}<1.0

0.8<I_{C2D}/I_{CD}<7

Among the above ranges, I_{G2D}/I_{GD} is preferably high, I_{S2D}/I_{SD} is preferably close to 1.0, and I_{C2D}/I_{CD} is preferably close to I_{S2D}/I_{SD}. Therefore, the peak intensity ratios of the graphite, silicon oxide, and carbon nanotube contained in the negative electrode preferably satisfy at least one of the following equations, and more preferably all of the following equations.

5<I_{G2D}/I_{G}D<10

0.5<I_{S2D}/I_{SD}<0.9

0.8<I_{C2D}/I_{CD}<1.2

When the ratio (S_{2D}/S_{D}) of the peak area (S_{2D}) of 2D band and the peak area (S_{D}) of D band in a Raman spectrum obtained by Raman spectroscopy is referred to as S_{G2D}/S_{GD} with respect to the graphite, S_{S2D}/S_{SD} with respect to the silicon oxide, and S_{C2D}/S_{CD} with respect to the carbon nanotube, the peak area ratios of the graphite, silicon oxide, and carbon nanotube contained in the negative electrode preferably satisfy at least one of the following equations, and more preferably all of the following equations.

0.5<S_{G2D}/S_{GD}<7

0.2<S_{S2D}/S_{SD}<1.0

0.8<S_{C2D}/S_{CD}<5

Among the above ranges, S_{G2D}/S_{GD} is preferably high, S_{S2D}/S_{SD} is preferably close to 1.0, and S_{S2D}/S_{SD} is preferably close to S_{S2D}/S_{SD}. Therefore, the peak area ratios of the graphite, silicon oxide, and carbon nanotube contained in the negative electrode preferably satisfy at least one of the following equations, and more preferably all of the following equations.

4<S_{G2D}/S_{GD}<7

0.5<S_{S2D}/S_{SD}<0.9

0.8<S_{S2D}/S_{SD}<1.2

The peak intensity (I_{2D}) of 2D band means the peak intensity of the highest peak in the range of 2600 to 2800 cm⁻¹. The peak intensity (I_{D}) of D band means the peak intensity of the highest peak in the range of 1000 to 1400 cm⁻¹. The peak intensity (I_{G}) of G band means the peak intensity of the highest peak in the range of 1500 to 1700 cm⁻¹.

The peak area (S_{2D}) of 2D band means the peak area in the range of 2600 to 2800 cm⁻¹. The peak area (S_{D}) of D band means the peak area in the range of 1000 to 1400 cm⁻¹. The peak area (S_{G}) of G band means the peak area in the range of 1500 to 1700 cm⁻¹.

In the present embodiment, the cycle characteristics may be further improved by controlling the particle size of the graphite and the silicon oxide and the length of the carbon nanotube in some cases. It is preferable that ranges of each median diameter satisfy

5.0 μm<D_{50G}<25.0 μm

0.5 μm<D_{50S}<10.0 μm

0.05 μm<D_{50C}<5.0 μm,

D_{50G}/D_{50S} is 0.5 to 2.0, and

D_{50G}/D_{50C} is 10 to 250,

wherein D_{50G} is a median diameter of the graphite particles, D_{50S} is a median diameter of the silicon oxide particles and D_{50C} is an average length of the carbon nanotube. By setting the particle sizes and length within the above ranges, preferred cycle characteristics can be obtained in some cases. This is presumably because the permeability of electrolyte solution is especially improved in the above ranges.

Negative electrode active materials other than the graphite and the silicon oxide may be additionally used in the negative electrode. The additional negative electrode active material is not limited, and known materials may be used. The examples thereof include silicon-based materials such as silicon alloys, silicon composite oxides, and silicon nitride; carbon-based materials such as hardly graphitizable carbon and amorphous carbon; metals such as Al, Pb, Sn, In, Bi, Ag, Ba, Ca, Hg, Pd, Pt, Te, Zn, La and alloys thereof; and metal oxides such as aluminum oxide, tin oxide, indium oxide, zinc oxide, and lithium oxide. These can be used alone or in combination of two or more.

A conductive assisting agent may be further added for the purpose of lowering the impedance. Examples of the additional conductive assisting agent include, flake-like, soot, and fibrous carbon fine particles and the like, for example, carbon black, acetylene black, Ketchen black, vapor grown carbon fibers and the like.

Examples of the negative electrode binder include polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide and the like. In addition to the above, styrene butadiene rubber (SBR) and the like can be used. When an aqueous binder such as an SBR emulsion is used, a thickener such as carboxymethyl cellulose (CMC) can also be used. The amount of the negative electrode binder is preferably 0.5 to 20 parts by mass based on 100 parts by mass of the negative electrode active material, from the viewpoint of the sufficient binding strength and the high energy density being in a trade-off relation with each other. The above-mentioned binders for a negative electrode may be mixed and used.

As the negative electrode current collector, from the view point of electrochemical stability, aluminum, nickel, copper, silver, and alloys thereof are preferred. As the shape thereof, foil, flat plate, mesh and the like are exemplified.

The negative electrode may be prepared by forming a negative electrode active material layer comprising the negative electrode active material and the negative electrode binder. Examples of a method for forming the negative electrode active material layer include a doctor blade method, a die coater method, a CVD method, a sputtering method, and the like. It is also possible that, after forming the negative electrode active material layer in advance, a thin film of aluminum, nickel or an alloy thereof may be formed by a method such as vapor deposition, sputtering or the like to obtain a negative electrode current collector.

<Positive Electrode>

The positive electrode includes a positive electrode active material capable of reversibly absorbing and desorbing lithium ions with charge and discharge and it has a structure in which the positive electrode active material is laminated on a current collector as a positive electrode active material layer integrated by a positive electrode binder.

The positive electrode active material in the present embodiment is not particularly limited as long as it is a material capable of absorb and desorb lithium, but from the viewpoint of high energy density, a compound having high capacity is preferably contained. Examples of the high capacity compound include lithium nickel composite oxides in which a part of the Ni of lithium nickelate (LiNiO₂) is replaced by another metal element, and layered lithium nickel composite oxides represented by the following formula (A) are preferred.

Li_{y}Ni₍₁₋ₓ₎MₓO₂ (A)

wherein 0≤x<1, 0<y≤1.2, and M is at least one element selected from the group consisting of Co, Al, Mn, Fe, Ti, and B.

It is preferred that the content of Ni is high, that is, x is less than 0.5, further preferably 0.4 or less in the formula (A). Examples of such compounds include Li_{α}Ni_{β}Co_{γ}Mn_{δ}O₂ (0<α≤1.2, β+γ+δ=1, β≥0.7, and γ≤0.2) and Li_{α}Ni_{β}Co_{γ}Al_{δ}O₂ (0<α≤1.2, β+γ+δ=1, β≥0.7, and γ≤0.2) and particularly include LiNi_{β}Co_{γ}Mn_{δ}O₂ (0.75≤β≤0.85, 0.05≤γ≤0.15, and 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ may be preferably used.

From the viewpoint of thermal stability, it is also preferred that the content of Ni does not exceed 0.5, that is, x is 0.5 or more in the formula (A). In addition, it is also preferred that particular transition metals do not exceed half. Examples of such compounds include Li_{α}Ni_{β}Co_{γ}Mn_{δ}O₂ (0<α≤1.2, β+γ+δ=1, 0.2≤β≤0.5, 0.1≤γ≤0.4, and 0.1≤δ≤0.4). More specific examples may include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (also including those in which the content of each transition metal fluctuates by about 10% in these compounds).

In addition, two or more compounds represented by the formula (A) may be mixed and used, and, for example, it is also preferred that NCM532 or NCM523 and NCM433 are mixed in the range of 9:1 to 1:9 (as a typical example, 2:1) and used. Further, by mixing a material in which the content of Ni is high (x is 0.4 or less in the formula (A)) and a material in which the content of Ni does not exceed 0.5 (x is 0.5 or more, for example, NCM433), a battery having high capacity and high thermal stability can also be formed.

Examples of the positive electrode active materials other than the above include lithium manganate having a layered structure or a spinel structure such as LiMnO₂, LiₓMn₂O₄ (0<x<2), Li₂MnO₃, and LiₓMn_{1.5}Ni_{0.5}O₄ (0<x<2); LiCoO₂ or materials in which a part of the transition metal in this material is replaced by other metal(s); materials in which Li is excessive as compared with the stoichiometric composition in these lithium transition metal oxides; materials having olivine structure such as LiFePO₄, and the like. In addition, materials in which a part of elements in these metal oxides is substituted by Al, Fe, P, Ti, Si, Pb, Sn, In, Bi, Ag, Ba, Ca, Hg, Pd, Pt, Te, Zn, La are also usable. The positive electrode active materials described above may be used alone or in combination of two or more.

Examples of the positive electrode binder include polyvinylidene fluoride, vinylidene fluoride-hexafluoropropylene copolymer, vinylidene fluoride-tetrafluoroethylene copolymer, polytetrafluoroethylene, polypropylene, polyethylene, polyimide, polyamideimide and the like. In addition to the above, styrene butadiene rubber (SBR) and the like can be used. When an aqueous binder such as an SBR emulsion is used, a thickener such as carboxymethyl cellulose (CMC) can also be used. Among them, polyvinylidene fluoride or polytetrafluoroethylene is preferable from the viewpoint of versatility and low cost, and polyvinylidene fluoride is more preferable. The above positive electrode binders may be mixed and used. The amount of the positive electrode binder is preferably 2 to 10 parts by mass based on 100 parts by mass of the positive electrode active material, from the viewpoint of the binding strength and energy density that are in a trade-off relation with each other.

For the coating layer containing the positive electrode active material, a conductive assisting agent may be added for the purpose of lowering the impedance. Examples of the conductive assisting agent include, flake-like, soot, and fibrous carbon fine particles and the like, for example, graphite, carbon black, acetylene black, vapor grown carbon fibers and the like.

As the positive electrode current collector, from the view point of electrochemical stability, aluminum, nickel, copper, silver, and alloys thereof are preferred. As the shape thereof, foil, flat plate, mesh and the like are exemplified. In particular, a current collector using aluminum, an aluminum alloy, or iron-nickel-chromium-molybdenum based stainless steel is preferable.

The positive electrode may be prepared by forming a positive active material layer comprising the positive electrode active material and the positive electrode binder. Examples of a method for forming the positive electrode active material layer include a doctor blade method, a die coater method, a CVD method, a sputtering method, and the like. It is also possible that, after forming the positive electrode active material layer in advance, a thin film of aluminum, nickel or an alloy thereof may be formed by a method such as vapor deposition, sputtering or the like to obtain a positive electrode current collector.

<Electrolyte Solution>

The electrolyte solution of the lithium ion secondary battery according to the present embodiment is not particularly limited, but is preferably a non-aqueous electrolyte solution containing a non-aqueous solvent and a supporting salt which are stable at the operating potential of the battery.

Examples of the non-aqueous solvent include aprotic organic solvents, for examples, cyclic carbonates such as propylene carbonate (PC), ethylene carbonate (EC) and butylene carbonate (BC); open-chain carbonates such as dimethyl carbonate (DMC), diethyl carbonate (DEC), ethyl methyl carbonate (EMC) and dipropyl carbonate (DPC); aliphatic carboxylic acid esters such as propylene carbonate derivatives, methyl formate, methyl acetate and ethyl propionate; ethers such as diethyl ether and ethyl propyl ether; phosphoric acid esters such as trimethyl phosphate, triethyl phosphate, tripropyl phosphate, trioctyl phosphate and triphenyl phosphate; and fluorinated aprotic organic solvents obtainable by substituting at least a part of the hydrogen atoms of these compounds with fluorine atom(s), and the like.

Among them, cyclic or open-chain carbonate(s) such as ethylene carbonate (EC), propylene carbonate (PC), butylene carbonate (BC), dimethyl carbonate (DMC), diethyl carbonate (DEC), ethyl methyl carbonate (MEC), dipropyl carbonate (DPC) and the like is preferably contained.

The non-aqueous solvent may be used alone, or in combination of two or more.

Examples of the supporting salt include LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(CF₃SO₂)₂ and the like. Supporting salts may be used alone or in combination of two or more. From the viewpoint of cost reduction, LiPF₆ is preferable.

The electrolyte solution may further contain additives. The additive is not particularly limited, and examples thereof include halogenated cyclic carbonates, unsaturated cyclic carbonates, cyclic or open-chain disulfonic acid esters, and the like. These compounds can improve the battery characteristics such as cycle characteristics. This is presumably because these additives decompose during charge/discharge of the lithium ion secondary battery to form a film on the surface of the electrode active material to inhibit decomposition of the electrolyte solution and supporting salt.

<Separator>

The separator may be of any type as long as it suppresses electron conduction between the positive electrode and the negative electrode, does not inhibit the permeation of charged substances, and has durability against the electrolyte solution. Specific examples of the material include polyolefins such as polypropylene and polyethylene, cellulose, polyethylene terephthalate, polyimide, polyvinylidene fluoride, and aromatic polyamides (aramid) such as polymetaphenylene isophthalamide, polyparaphenylene terephthalamide and copolyparaphenylene 3,4′-oxydiphenylene terephthalamide, and the like. These can be used as porous films, woven fabrics, nonwoven fabrics or the like.

<Secondary Battery>

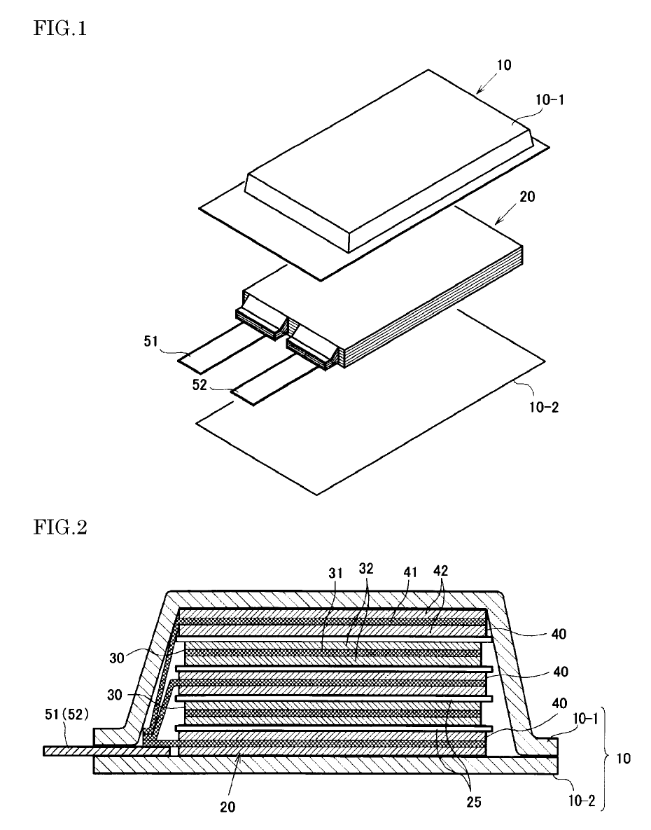

The lithium ion secondary battery according to the present embodiment may be, for example, a secondary battery having a structure as shown in FIGS. 1 and 2. This secondary battery comprises a battery element 20, a film package 10 housing the battery element 20 together with an electrolyte, and a positive electrode tab 51 and a negative electrode tab 52 (hereinafter these are also simply referred to as “electrode tabs”).

In the battery element 20, a plurality of positive electrodes 30 and a plurality of negative electrodes 40 are alternately stacked with separators 25 sandwiched therebetween as shown in FIG. 2. In the positive electrode 30, an electrode material 32 is applied to both surfaces of a metal foil 31, and also in the negative electrode 40, an electrode material 42 is applied to both surfaces of a metal foil 41 in the same manner. The present invention is not necessarily limited to stacking type batteries and may also be applied to batteries such as a winding type.

As shown in FIGS. 1 and 2, the secondary battery may have an arrangement in which the electrode tabs are drawn out to one side of the outer package, but the electrode tab may be drawn out to both sides of the outer package. Although detailed illustration is omitted, the metal foils of the positive electrodes and the negative electrodes each have an extended portion in part of the outer periphery. The extended portions of the negative electrode metal foils are brought together into one and connected to the negative electrode tab 52, and the extended portions of the positive electrode metal foils are brought together into one and connected to the positive electrode tab 51 (see FIG. 2). The portion in which the extended portions are brought together into one in the stacking direction in this manner is also referred to as a “current collecting portion” or the like.

The film package 10 is composed of two films 10-1 and 10-2 in this example. The films 10-1 and 10-2 are heat-sealed to each other in the peripheral portion of the battery element 20 and hermetically sealed. In FIG. 1, the positive electrode tab 51 and the negative electrode tab 52 are drawn out in the same direction from one short side of the film package 10 hermetically sealed in this manner.

Of course, the electrode tabs may be drawn out from different two sides respectively. In addition, regarding the arrangement of the films, in FIG. 1 and FIG. 2, an example in which a cup portion is formed in one film 10-1 and a cup portion is not formed in the other film 10-2 is shown, but other than this, an arrangement in which cup portions are formed in both films (not illustrated), an arrangement in which a cup portion is not formed in either film (not illustrated), and the like may also be adopted.

<Method for Manufacturing Lithium Ion Secondary Battery>

The lithium ion secondary battery according to the present embodiment can be manufactured according to conventional method. An example of a method for manufacturing a lithium ion secondary battery will be described taking a stacked laminate type lithium ion secondary battery as an example. First, in the dry air or an inert atmosphere, the positive electrode and the negative electrode are placed to oppose to each other via a separator to form the above-mentioned electrode element. Next, this electrode element is accommodated in an outer package (container), an electrolyte solution is injected, and the electrodes are impregnated with the electrolyte solution. Thereafter, the opening of the outer package is sealed to complete the lithium ion secondary battery.

<Assembled Battery>

A plurality of the lithium ion secondary batteries according to the present embodiment may be combined to form an assembled battery. The assembled battery may be configured by connecting two or more lithium ion secondary batteries according to the present embodiment in series or in parallel or in combination of both. The connection in series and/or parallel makes it possible to adjust the capacitance and voltage freely. The number of lithium ion secondary batteries included in the assembled battery can be set appropriately according to the battery capacity and output.

<Vehicle>

The lithium ion secondary battery or the assembled battery according to the present embodiment can be used in vehicles. Vehicles according to an embodiment of the present invention include hybrid vehicles, fuel cell vehicles, electric vehicles (besides four-wheel vehicles (cars, trucks, commercial vehicles such as buses, light automobiles, etc.) two-wheeled vehicle (bike) and tricycle), and the like. The vehicles according to the present embodiment is not limited to automobiles, it may be a variety of power source of other vehicles, such as a moving body like a train.

<Power Storage Equipment>

The lithium ion secondary battery or the assembled battery according to the present embodiment can be used in power storage system. The power storage systems according to the present embodiment include, for example, those which is connected between the commercial power supply and loads of household appliances and used as a backup power source or an auxiliary power in the event of power outage or the like, or those used as a large scale power storage that stabilize power output with large time variation supplied by renewable energy, for example, solar power generation.

### EXAMPLE

### Example 1

(Preparation of Lithium Ion Secondary Battery)

Polyvinylidene fluoride (PVdF) as a binder in an amount of 3 mass % based on the mass of the positive electrode active material, and the layered lithium nickel composite oxide (LiNi_{0.8}Co_{0.15}Al_{0.05}O₂) in a remaining amount other than the above, are dispersed uniformly in NMP using a rotation revolution type three-axis mixer excellent in stirring and mixing, to prepare a positive electrode slurry. The positive electrode slurry was uniformly applied to a positive electrode current collector of aluminum foil with a thickness of 20 μm using a coater. After drying by evaporating NMP, the back side was also coated in the same way. After drying, the density was adjusted by roll press, to prepare positive electrode active material layers on both sides of the current collector. Mass per unit area of the positive electrode active material layers was 50 mg/cm².

The mixing ratio of artificial graphite, SiO with carbon coating, and carbon nanotubes in the negative electrode active material was set to 93:5:2, and they were dispersed uniformly in 1% by mass aqueous solution of CMC (carboxymethyl cellulose). Then, a SBR binder (in an amount of 2 mass % in the negative electrode) was added there to prepare a negative electrode slurry. The negative electrode slurry was uniformly applied to a negative electrode current collector of copper foil with a thickness of 10 μm using a coater. After drying by evaporating water, the back side was also coated in the same way. After drying, the density was adjusted by roll press, to prepare negative electrode active material layers on both sides of the current collector. Mass per unit area of the negative electrode active material layers was 20 mg/cm².

Raman spectroscopy was performed on the negative electrode materials with semiconductor laser having a wavelength of 532 nm. The energy density was set to 0.1 mW and the measurement was performed with low laser intensity which does not damage the samples. The measurement range of Raman spectroscopy was 50 to 3500 cm⁻¹. With respect to peak intensity of each material in the profile of Raman spectroscopy, the highest peak intensity between 1000 cm⁻¹ and 1400 cm⁻¹ was referred to as I_{D}, the highest peak intensity between 1500 cm⁻¹ and 1700 cm⁻¹ was referred to as I_{G}, and the highest peak intensity between 2600 cm⁻¹ and 2800 cm⁻¹ was referred to as I_{2D}. With respect to peak area, the area surrounded by a Raman profile and a base line in the range of 1000 to 1400 cm⁻¹ was referred to as S_{D}, the area surrounded by a Raman profile and a base line in the range of 1500 to 1700 cm⁻¹ was referred to as S_{G}, the area surrounded by a Raman profile and a base line in the range of 2600 to 2800 cm⁻¹ was referred to as S_{2D}. Raman spectroscopy of the graphite, silicon oxide, and carbon nanotubes which were used as the negative electrode material was performed to calculate the peak intensity ratios and the peak area ratios respectively. Hereinafter, the peak intensity ratios and the peak area ratios of each negative electrode material will be indicated by the abbreviated names used above.

As an electrolyte solution, 1 mol/L of LiPF₆ as an electrolyte was dissolved in a solvent of ethylene carbonate (EC):diethyl carbonate (DEC)=30:70 (vol %).

The resulting positive electrode was cut into 13 cm×7 cm, and the negative electrode was cut into 12 cm×6 cm. The both surfaces of the positive electrode was covered by a polypropylene separator of 14 cm×8 cm, the negative active material layer was disposed thereon so as to face the positive electrode active material layer, to prepare an electrode stack. Next, the electrode stack was sandwiched by two sheets of aluminum laminate film of 15 cm×9 cm, the three sides excluding one long side were heat sealed with a seal width of 8 mm. After injecting the electrolyte solution, the remaining side was heat sealed, to produce a laminate cell type battery.

<Measurement of Capacity Retention Ratio>

300 times of charge-discharge cycle test were performed in a thermostatic oven at 45° C. to measure the capacity retention ratio and to evaluate the lifetime. In the charge, the secondary battery was subjected to constant current charge at 1 C up to maximum voltage of 4.2 V and then subjected to constant voltage charge at 4.2 V, and the total charge time was 2.5 hours. In the discharge, the secondary battery was subjected to constant current discharge at 1 C to 2.5 V. The capacity after the charge-discharge cycle test was measured, and the ratio (%) to the capacity before the charge-discharge cycle test was calculated. The results are shown in Table 1.

<Measurement of Resistance Increase Rate>

The values of electrical resistance (Rsol) were obtained by AC impedance measurement. The resistance increase rate of the battery is a value obtained by dividing the value of electrical resistance (Rsol) after 500 times of the charge-discharge cycle test by the value of electrical resistance (Rsol) before the charge-discharge cycle test when the value of electrical resistance (Rsol) before the charge-discharge cycle test is defined as 1. Small this resistance increase rate means that resistance components are low, which is preferable because long-life battery can be provided.

### Examples 2 to 35

Raman spectroscopy was conducted in the same manner as in Example 1. The graphite, SiO having carbon coating, and carbon nanotubes, showing peak intensity ratios and peak area ratios of a Raman spectrum shown in Tables 1 to 3, were used. Except for that, the batteries were prepared and cycle retention ratios and resistance increase rates were measured in the same manner as in Example 1.

### Comparative Examples 1 to 6

Raman spectroscopy was conducted in the same manner as in Example 1. The Graphite, SiO having carbon coating, and carbon nanotubes, showing peak intensity ratios and peak area ratios of a Raman spectrum shown in Tables 1 to 3, were used. Except for that, the batteries were prepared and cycle retention ratios and resistance increase rates were measured in the same manner as in Example 1. All of the carbon nanotubes of Comparative examples 1 to 6 did not show the peak of 2D band in a Raman spectrum, and the peak intensity ratios of 2D band and D band were 0.

Table 1 shows the results of comparing batteries using carbon nanotubes showing the peak of 2D band in Raman spectrum in the negative electrode and batteries using carbon nanotubes not showing it in the negative electrode. When the carbon nanotubes showing the peak of 2D band was used, an increase in cycle retention ratio and a decrease in resistance increase rate were confirmed and it was demonstrated that the cycle characteristics of batteries were improved.

TABLE 1

| | | | | | | | | | | | | | Cycle | Resistance |
|---|---|---|---|---|---|---|---|---|---|---|---|---|---|---|
| | | S_{GG}/ | I_{SG}/ | S_{SG}/ | I_{CG}/ | S_{CG}/ | I_{G2D}/ | | | | | | retention | increase |
| | I_{GG}/I_{GD} | S_{GD} | I_{SD} | S_{SD} | I_{CD} | S_{CD} | I_{GD} | S_{G2D}/S_{GD} | I_{S2D}/I_{SD} | S_{S2D}/S_{SD} | I_{C2D}/I_{CD} | S_{C2D}/S_{CD} | ratio (%) | rate |
| Example 1 | 5 | 2.5 | 0.5 | 0.3 | 10 | 5 | 3 | 4 | 0.3 | 0.3 | 1 | 1.1 | 80 | 1.30 |
| Comparative | 5 | 2.5 | 0.5 | 0.3 | 10 | 5 | 3 | 4 | 0.3 | 0.3 | 0 | 0 | 75 | 1.50 |
| example 1 | | | | | | | | | | | | | | |
| Example 2 | 5 | 2.5 | 1 | 0.6 | 1 | 0.95 | 3 | 4 | 0.3 | 0.3 | 1 | 1.1 | 85 | 1.24 |
| Comparative | 5 | 2.5 | 1 | 0.6 | 1 | 0.95 | 3 | 4 | 0.3 | 0.3 | 0 | 0 | 76 | 1.51 |
| example 2 | | | | | | | | | | | | | | |
| Example 3 | 10 | 5 | 0.5 | 0.3 | 1 | 0.95 | 3 | 4 | 0.3 | 0.3 | 1 | 1.1 | 82 | 1.28 |
| Comparative | 10 | 5 | 0.5 | 0.3 | 1 | 0.95 | 3 | 4 | 0.3 | 0.3 | 0 | 0 | 78 | 1.52 |
| example 3 | | | | | | | | | | | | | | |
| Example 4 | 10 | 5 | 1.7 | 1 | 10 | 5 | 3 | 4 | 0.3 | 0.3 | 1 | 1.1 | 82 | 1.28 |
| Comparative | 10 | 5 | 1.7 | 1 | 10 | 5 | 3 | 4 | 0.3 | 0.3 | 0 | 0 | 78 | 1.52 |
| example 4 | | | | | | | | | | | | | | |
| Example 5 | 20 | 10 | 1 | 0.6 | 1 | 0.95 | 3 | 4 | 0.3 | 0.3 | 1 | 1.1 | 88 | 1.22 |
| Example 6 | 20 | 10 | 1 | 0.6 | 1 | 0.95 | 3 | 4 | 0.3 | 0.3 | 3.5 | 1.8 | 86 | 1.23 |
| Comparative | 20 | 10 | 1 | 0.6 | 1 | 0.95 | 3 | 4 | 0.3 | 0.3 | 0 | 0 | 76 | 1.51 |
| example 5 | | | | | | | | | | | | | | |
| Example 7 | 20 | 10 | 1.7 | 1 | 10 | 5 | 3 | 4 | 0.3 | 0.3 | 1 | 1.1 | 82 | 1.28 |
| Comparative | 20 | 10 | 1.7 | 1 | 10 | 5 | 3 | 4 | 0.3 | 0.3 | 0 | 0 | 75 | 1.50 |
| example 6 | | | | | | | | | | | | | | |

Table 2 summarizes the results of Examples in which the peak ratios of G band and D band of graphite, silicon oxide, and carbon nanotubes were changed.

TABLE 2

| | | | | | | | | | | | | | Cycle | Resistance |
|---|---|---|---|---|---|---|---|---|---|---|---|---|---|---|
| | I_{GG}/ | S_{GG}/ | I_{SG}/ | S_{SG}/ | I_{CG}/ | S_{CG}/ | | | | | | | retention | increase |
| | I_{GD} | S_{GD} | I_{SD} | S_{SD} | I_{CD} | S_{CD} | I_{G2D}/I_{GD} | S_{G2D}/S_{GD} | I_{S2D}/I_{SD} | S_{S2D}/S_{SD} | I_{C2D}/I_{CD} | S_{C2D}/S_{CD} | ratio (%) | rate |
| Example 8 | 5 | 2.5 | 0.5 | 0.3 | 1 | 0.95 | 3 | 4 | 0.3 | 0.3 | 1 | 1.1 | 80 | 1.30 |
| Example 9 | 5 | 2.5 | 0.5 | 0.3 | 2 | 1.6 | 3 | 4 | 0.3 | 0.3 | 1 | 1.1 | 80 | 1.30 |
| Example 1 | 5 | 2.5 | 0.5 | 0.3 | 10 | 5 | 3 | 4 | 0.3 | 0.3 | 1 | 1.1 | 80 | 1.30 |
| Example 2 | 5 | 2.5 | 1 | 0.6 | 1 | 0.95 | 3 | 4 | 0.3 | 0.3 | 1 | 1.1 | 85 | 1.24 |
| Example 10 | 5 | 2.5 | 1 | 0.6 | 2 | 1.6 | 3 | 4 | 0.3 | 0.3 | 1 | 1.1 | 84 | 1.25 |
| Example 11 | 5 | 2.5 | 1 | 0.6 | 10 | 5 | 3 | 4 | 0.3 | 0.3 | 1 | 1.1 | 83 | 1.26 |
| Example 12 | 5 | 2.5 | 1.7 | 1 | 1 | 0.95 | 3 | 4 | 0.3 | 0.3 | 1 | 1.1 | 80 | 1.30 |
| Example 13 | 5 | 2.5 | 1.7 | 1 | 2 | 1.6 | 3 | 4 | 0.3 | 0.3 | 1 | 1.1 | 80 | 1.30 |
| Example 14 | 5 | 2.5 | 1.7 | 1 | 10 | 5 | 3 | 4 | 0.3 | 0.3 | 1 | 1.1 | 80 | 1.30 |
| Example 3 | 10 | 5 | 0.5 | 0.3 | 1 | 0.95 | 3 | 4 | 0.3 | 0.3 | 1 | 1.1 | 82 | 1.28 |
| Example 15 | 10 | 5 | 0.5 | 0.3 | 2 | 1.6 | 3 | 4 | 0.3 | 0.3 | 1 | 1.1 | 82 | 1.28 |
| Example 16 | 10 | 5 | 0.5 | 0.3 | 10 | 5 | 3 | 4 | 0.3 | 0.3 | 1 | 1.1 | 82 | 1.28 |
| Example 17 | 10 | 5 | 1 | 0.6 | 1 | 0.95 | 3 | 4 | 0.3 | 0.3 | 1 | 1.1 | 86 | 1.23 |
| Example 18 | 10 | 5 | 1 | 0.6 | 2 | 1.6 | 3 | 4 | 0.3 | 0.3 | 1 | 1.1 | 85 | 1.24 |
| Example 19 | 10 | 5 | 1 | 0.6 | 10 | 5 | 3 | 4 | 0.3 | 0.3 | 1 | 1.1 | 84 | 1.25 |
| Example 20 | 10 | 5 | 1.7 | 1 | 1 | 0.95 | 3 | 4 | 0.3 | 0.3 | 1 | 1.1 | 82 | 1.28 |
| Example 21 | 10 | 5 | 1.7 | 1 | 2 | 1.6 | 3 | 4 | 0.3 | 0.3 | 1 | 1.1 | 82 | 1.28 |
| Example 4 | 10 | 5 | 1.7 | 1 | 10 | 5 | 3 | 4 | 0.3 | 0.3 | 1 | 1.1 | 82 | 1.28 |
| Example 22 | 20 | 10 | 0.5 | 0.3 | 1 | 0.95 | 3 | 4 | 0.3 | 0.3 | 1 | 1.1 | 84 | 1.25 |
| Example 23 | 20 | 10 | 0.5 | 0.3 | 2 | 1.6 | 3 | 4 | 0.3 | 0.3 | 1 | 1.1 | 83 | 1.26 |
| Example 24 | 20 | 10 | 0.5 | 0.3 | 10 | 5 | 3 | 4 | 0.3 | 0.3 | 1 | 1.1 | 82 | 1.28 |
| Example 5 | 20 | 10 | 1 | 0.6 | 1 | 0.95 | 3 | 4 | 0.3 | 0.3 | 1 | 1.1 | 88 | 1.22 |
| Example 25 | 20 | 10 | 1 | 0.6 | 2 | 1.6 | 3 | 4 | 0.3 | 0.3 | 1 | 1.1 | 85 | 1.24 |
| Example 26 | 20 | 10 | 1 | 0.6 | 10 | 5 | 3 | 4 | 0.3 | 0.3 | 1 | 1.1 | 84 | 1.25 |
| Example 27 | 20 | 10 | 1.7 | 1 | 1 | 0.95 | 3 | 4 | 0.3 | 0.3 | 1 | 1.1 | 83 | 1.26 |
| Example 28 | 20 | 10 | 1.7 | 1 | 2 | 1.6 | 3 | 4 | 0.3 | 0.3 | 1 | 1.1 | 83 | 1.26 |
| Example 7 | 20 | 10 | 1.7 | 1 | 10 | 5 | 3 | 4 | 0.3 | 0.3 | 1 | 1.1 | 82 | 1.28 |

Table 3 summarizes the results of Examples in which the peak ratios of 2D band and D band of graphite, silicon oxide, and carbon nanotubes were changed.

TABLE 3

| | | | | | | | | | | | | | Cycle | Resistance |
|---|---|---|---|---|---|---|---|---|---|---|---|---|---|---|
| | I_{GG}/ | S_{GG}/ | I_{SG}/ | S_{SG}/ | I_{CG}/ | S_{CG}/ | | | | | | | retention | increase |
| | I_{GD} | S_{GD} | I_{SD} | S_{SD} | I_{CD} | S_{CD} | I_{G2D}/I_{GD} | S_{G2D}/S_{GD} | I_{S2D}/I_{SD} | S_{S2D}/S_{SD} | I_{C2D}/I_{CD} | S_{C2D}/S_{CD} | ratio (%) | rate |
| Example 29 | 20 | 10 | 1 | 0.6 | 1 | 0.95 | 0.2 | 0.25 | 0.1 | 0.1 | 0.5 | 0.3 | 82 | 1.28 |
| Example 30 | 20 | 10 | 1 | 0.6 | 1 | 0.95 | 0.2 | 0.25 | 0.1 | 0.1 | 3.5 | 1.8 | 85 | 1.24 |
| Example 31 | 20 | 10 | 1 | 0.6 | 1 | 0.95 | 0.2 | 0.25 | 0.3 | 0.3 | 0.1 | 0.1 | 80 | 1.30 |
| Example 32 | 20 | 10 | 1 | 0.6 | 1 | 0.95 | 3 | 4 | 0.1 | 0.1 | 0.1 | 0.1 | 80 | 1.30 |
| Example 6 | 20 | 10 | 1 | 0.6 | 1 | 0.95 | 3 | 4 | 0.3 | 0.3 | 3.5 | 1.8 | 86 | 1.23 |
| Example 5 | 20 | 10 | 1 | 0.6 | 1 | 0.95 | 3 | 4 | 0.3 | 0.3 | 1 | 1.1 | 88 | 1.22 |
| Example 33 | 20 | 10 | 1 | 0.6 | 1 | 0.95 | 3 | 4 | 0.8 | 0.8 | 3.5 | 1.8 | 86 | 1.23 |
| Example 34 | 20 | 10 | 1 | 0.6 | 1 | 0.95 | 3 | 10 | 0.3 | 0.3 | 3.5 | 1.8 | 90 | 1.20 |
| Example 35 | 20 | 10 | 1 | 0.6 | 1 | 0.95 | 3 | 10 | 0.8 | 0.3 | 1 | 1.1 | 93 | 1.18 |

### INDUSTRIAL APPLICABILITY

The battery according to the present invention can be utilized in, for example, all the industrial fields requiring a power supply and the industrial fields pertaining to the transportation, storage and supply of electric energy. Specifically, it can be used in, for example, power supplies for mobile equipment such as cellular phones and notebook personal computers; power supplies for electrically driven vehicles including an electric vehicle, a hybrid vehicle, an electric motorbike and an electric-assisted bike, and moving/transporting media such as trains, satellites and submarines; backup power supplies for UPSs; and electricity storage facilities for storing electric power generated by photovoltaic power generation, wind power generation and the like.

### EXPLANATION OF REFERENCE

10 film package
20 battery element
25 separator
30 positive electrode
40 negative electrode

1. A lithium ion secondary battery comprising a negative electrode comprising
a carbon nanotube having a peak between 2600 and 2800 cm⁻¹ in a Raman spectrum obtained by Raman spectroscopy,
a graphite, and
a silicon oxide having a composition represented by SiOₓ (0<x≤2).

2. The lithium ion secondary battery according to claim 1, wherein peak intensity ratios of the graphite, the silicon oxide, and the carbon nanotube contained in the negative electrode satisfy the following equations:
1<I_{GG}/I_{GD}<20
0.8<I_{SG}/I_{SD}<2
1<I_{CG}/I_{CD}<16
wherein a ratio (I_{G}/I_{D}) of a peak intensity (I_{G}) between 1500 and 1700 cm⁻¹ and a peak intensity (I_{D}) between 1000 and 1400 cm⁻¹ in a Raman spectrum obtained by Raman spectroscopy is referred to as I_{GG}/I_{GD} with respect to the graphite, I_{SG}/I_{SD} with respect to the silicon oxide, and I_{CG}/I_{CD} with respect to the carbon nanotube.

3. The lithium ion secondary battery according to claim 2, wherein the peak intensity ratios of the graphite, the silicon oxide, and the carbon nanotube satisfy the following equations:
10<I_{GG}/I_{GD}<20
0.9<I_{SG}/I_{SD}<1.2
1<I_{CG}/I_{CD}<2.

4. The lithium ion secondary battery according to claim 1, wherein peak area ratios of the graphite, the silicon oxide, and the carbon nanotube contained in the negative electrode satisfy the following equations:
1<S_{GG}/S_{GD}<10
0.8<S_{SG}/S_{SD}<1.2
1<S_{CG}/S_{CD}<10
wherein a ratio (S_{G}/S_{D}) of a peak area (S_{G}) between 1500 and 1700 cm⁻¹ and a peak area (S_{D}) between 1000 and 1400 cm⁻¹ in a Raman spectrum obtained by Raman spectroscopy is referred to as S_{GG}/S_{GD} with respect to the graphite, S_{SG}/S_{SD} with respect to the silicon oxide, and S_{CG}/S_{CD} with respect to the carbon nanotube.

5. The lithium ion secondary battery according to claim 4, wherein the peak area ratios of the graphite, the silicon oxide, and the carbon nanotube satisfy the following equations:
4<S_{GG}/S_{GD}<10
0.9<S_{SG}/S_{SD}<1.2
1<S_{CG}/S_{CD}<2.

6. The lithium ion secondary battery according to claim 1, wherein peak intensity ratios of the graphite, the silicon oxide, and the carbon nanotube contained in the negative electrode satisfy at least one of the following equations:
0.5<I_{G2D}/I_{GD}<10
0.2<I_{S2D}/I_{SD}<1.0
0.8<I_{C2D}/I_{CD}<7
wherein a ratio (I_{2D}/I_{D}) of a peak intensity (I_{2D}) between 2600 and 2800 cm⁻¹ and a peak intensity (I_{D}) between 1000 and 1400 cm⁻¹ in a Raman spectrum obtained by Raman spectroscopy is referred to as I_{G2D}/I_{GD} with respect to the graphite, I_{S2D}/I_{SD} with respect to the silicon oxide, and I_{C2D}/I_{CD} with respect to the carbon nanotube.

7. The lithium ion secondary battery according to claim 6, wherein the peak intensity ratios of the graphite, the silicon oxide, and the carbon nanotube contained in the negative electrode satisfy the following equations:
5<I_{G2D}/I_{GD}<10
0.5<I_{S2D}/I_{SD}<0.9
0.8<I_{C2D}/I_{CD}<1.2.

8. The lithium ion secondary battery according to claim 1, wherein the negative electrode comprises the carbon nanotube in an amount of 20% by mass or less based on the total amount of a negative electrode active material.

9. The lithium ion secondary battery according to claim 8, wherein the negative electrode comprises the carbon nanotube in an amount of 5% by mass or less based on the total amount of a negative electrode active material.

10. A vehicle equipped with the lithium ion secondary battery according to claim 1.

11. A method of producing a lithium ion secondary battery comprising:
a step of stacking a positive electrode and a negative electrode via a separator to produce an electrode element and
a step of enclosing the electrode element and an electrolyte solution in an outer package, wherein
the negative electrode comprises
a carbon nanotube having a peak between 2600 and 2800 cm⁻¹ in a Raman spectrum obtained by Raman spectroscopy,
a graphite, and
a silicon oxide having a composition represented by SiOₓ (0<x≤2).
